(19) United States
(12) Patent Application Publication
(10) Pub. No.: US 2024/0072345 A1
(43) Pub. Date: Feb. 29, 2024

(54) Battery Assembly and Methods

(71) Applicant: 3M INNOVATIVE PROPERTIES COMPANY, St. Paul, MN (US)

(72) Inventors: Jose Maria Benito, Madrid (SP); Maria Jose Sanchez, Madrid (SP); Stephane Stephan, Feucherolles (FR); Pingfan Wu, Woodbury, MN (US); Jean Louis Silvestre, Vaux Sur Seine (FR); David Bernard Andre Descoins, Belle Eglise (FR)

(21) Appl. No.: 18/269,366

(22) PCT Filed: Dec. 23, 2021
(86) PCT No.: PCT/IB2021/062271

§ 371 Date: Jun. 23, 2023

Related U.S. Application Data
(60) Provisional application No. 63/131,126, filed on Dec. 28, 2020.

(51) Int. Cl. H01M 50/202; H01M 50/143; H01M 50/44; H01M 50/494; H01M 50/505

(52) U.S. Cl. CPC H01M 50/202; H01M 50/143; H01M 50/44; H01M 50/494; H01M 50/505

(57) ABSTRACT

Provided is a battery assembly that includes an electrically-conductive housing (510A, 510B), one or more battery modules (512) electrically coupled to a busbar (522), the one or more battery modules and busbar being received in the housing. A non-woven core layer (506) is disposed between the busbar and electrically-conductive housing, the non-woven core layer comprising a plurality of fibers, the plurality of fibers comprising 60-100 wt % of oxidized polyacrylonitrile fibers. The non-woven core layer can exhibit a breakdown voltage of at least 0.9 kV at ambient conditions after exposure to 500° C. for 5 minutes.

### FIELD OF THE INVENTION

Provided are battery assemblies and methods related thereof, including battery assemblies and related methods useful in automotive and aerospace applications.

### BACKGROUND

With the benefits of reduced emissions and fuel cost savings, electric vehicle drivetrains are rapidly displacing traditional internal combustion engines in the transportation sector. As these technologies are developed and scaled up, use of rechargeable batteries to power these drivetrains has greatly expanded, with some battery assemblies containing thousands of individual cells. The evolution of this technology has raised particular technical challenges around managing risks associated with these high voltage and high current devices in automotive vehicles.

Battery assemblies are generally governed by a battery management system that ensures that a battery is working within a specified nominal range of operating and environmental factors, including charge and discharge currents, cell voltage, and temperature. Common battery systems operate best in a relatively narrow operating range for temperature, generally in the range of from about 15° C. to about 45° C. Outside of this range, the functional safety, service life, and cycle stability of the battery can be compromised. If the temperature exceeds a critical level, thermal runaway occurs. Thermal runaway occurs as a result of a chain reaction in the battery, where temperatures exceeding 700° C. lead to decomposition of battery components, gas formation, and ignition across many cells in the battery.

### SUMMARY

One of the primary causes of thermal runaway is an internal short circuit within the battery assembly. Short circuits can occur as a result of separators within the battery wearing out, or damage to the battery. To avoid this, battery assemblies contain many layers of insulation within the housing of the battery to electrically isolate electrical conductors within the battery from inadvertently contacting each other or the outside casing of the battery assembly, which is commonly made from metal. These materials also help avoid low current leakage which can induce undesirable self-discharge in the battery.

Herein are described nonwoven materials that serve as a flexible electrical and/or thermal insulator, either under the lid, on the bottom, between modules in a battery pack, or even between neighboring cells of the battery pack. Advantageously, these materials can be comprised of oxidized polyacrylonitrile (OPAN) fibers that not only have an extremely high electrical resistance but also provide high temperature resistance and fire resistance while maintaining a very high electrical resistance and dielectric breakdown voltage. As a further advantage, these materials can be made resiliently compressible and conformable to fill complex and irregular enclosures within a battery assembly. These properties enable these materials to not only help avoid battery fires but also protect vehicle occupants and structures exterior to the battery assembly in the event a battery fire occurs.

In a first aspect, a battery assembly is provided. The battery assembly comprises: an electrically-conductive housing; one or more battery modules electrically coupled to a busbar, the one or more battery modules and busbar being received in the housing; and a non-woven core layer disposed between the busbar and electrically-conductive housing, wherein the non-woven core layer comprises a plurality of fibers, the plurality of fibers comprising 60-100 wt % of oxidized polyacrylonitrile fibers.

In a second aspect, a method of electrically insulating a battery housing from a busbar within a battery assembly, the method comprising: disposing a non-woven core layer on either the busbar or at least a portion of the battery housing; bringing together the battery housing and the busbar whereby the non-woven core layer is disposed therebetween, wherein the non-woven core layer comprises a plurality of fibers, the plurality of fibers comprising 60-100 wt % of oxidized polyacrylonitrile fibers.

Notably, while organic materials tend to melt away or shrink into discontinuous pieces at high temperatures (e.g., at 500° C. or 800° C.), webs of oxidized polyacrylonitrile fibers can maintain their entangled structure and keep opposing electrodes separated for an extended period of time.

### BRIEF DESCRIPTION OF THE DRAWINGS

FIG. 1 is an elevational cross-sectional view of an electrically-insulated subassembly for installation into a battery assembly according to one exemplary embodiment.

FIG. 2-4 are perspective views of battery subassemblies according to various embodiments, with FIGS. 2 and 4 shown in exploded view.

FIG. 5 is an exploded perspective view of a battery assembly according to an exemplary embodiment;

FIG. 6 is a perspective view showing layers of a multi-layered electrical insulator according to another embodiment.

FIG. 7 is an exploded perspective view of a battery subassembly including the multi-layered electrical insulator of FIG. 6.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:
“ambient conditions” means at 23° C., 101.3 kPa pressure, and 30% relative humidity;
“average” means number average, unless otherwise specified;
“copolymer” refers to polymers made from repeat units of two or more different polymers and includes random, block and star (e.g. dendritic) copolymers;
“non-woven core layer” means a plurality of fibers characterized by entanglement or point bonding of the fibers to form a sheet or mat exhibiting a structure of individual fibers or filaments which are interlaid, but not in an identifiable manner as in a knitted fabric;
“polymer” means a relatively high molecular weight material having a molecular weight of at least 10,000 g/mol;
“size” refers to the longest dimension of a given object or surface;
“substantially” means to a significant degree, as in an amount of at least 30%, 40, 50, 60, 70, 80, 90, 95, 96, 97, 98, 99, 99.5, 99.9, 99.99, or 99.999%, or 100%; and
“thickness” means the distance between opposing sides of a layer or multilayer article.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

### Battery Assemblies

Various types of battery cells exist, including cylindrical, prismatic, and pouch cells. Pouch cells can have a maximum excursion temperature at 500° C., while some high-density designs have a maximum excursion temperature of 800° C. Excursion temperature is defined as a temperature that may be encountered in an adverse situation but only sustained over a relatively short period of time, such as when thermal runaway occurs.

For battery safety or thermal runaway protection, useful materials can maintain thermal, electrical and mechanical insulation performance at a given maximum temperature (e.g., 500° C.) during an excursion period (e.g., 5 minutes). Such material requirements can include:
Thermal insulation: While one major surface of the insulation is heated from ambient temperature to a maximum temperature (e.g., 500° C. or 800° C.), the temperature of the opposing major surface should be maintained at or below a certain value (e.g., 400° C., 390, 380, 370, 360, 350, 340, 330, 320, 310, 300, 290, 280, 270, 260° C. or 250° C.) over a specified time frame (e.g., 5 minutes);
Electrical insulation: No electrical breakdown occurs at the maximum temperature (e.g., breakdown voltage is maintained higher than 1 kV); and
Mechanical separation: In the event thermal runaway occurs, during an excursion period (5 minutes) the insulation material can maintain the gap between two metal electrodes or metal plates such that electrical breakdown is avoided and/or thermal transmission is significantly reduced.

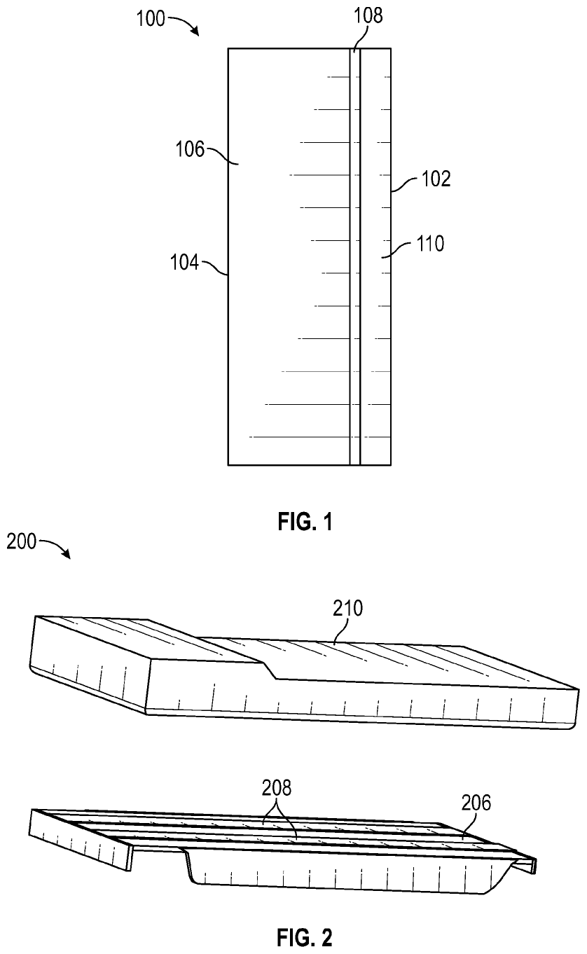

A generalized subassembly containing such a material for incorporation into a battery assembly is shown in FIG. 1 and referred to by the numeral 100 herein. As shown, the subassembly 100 has a multi-layered construction with an outward-facing major surface 102 and inward-facing major surface 104. The layers of the subassembly 100 include a non-woven core layer 106 exposed at the inward-facing major surface 104, an adhesive layer 108, and an electrically-conductive plate 110 that is exposed at the outward-facing major surface 102.

Optionally and as shown, the non-woven core layer 106, adhesive layer 108, and plate 110 directly contact each other as shown in FIG. 1. Alternatively, one or more additional layers, such as primers, tie layers, scrims, or other functional layers, may be disposed between adjacent layers of the subassembly 100 or on either major surface 102, 104 of the subassembly or any of its constituent layers. While the subassembly 100 is shown having a generally rectilinear shape in this figure, it is to be understood that it could include bends and/or curved contours based on the shape of the battery assembly.

The non-woven core layer 106 is an electrical insulator. Preferably, the non-woven core layer 106 is made from a carbonized and/or other non-meltable fiber and displays an electrical resistivity of at least 0.1 G-ohm meters, at least 1 G-ohm meters, at least 10 G-ohm meters, or in some embodiments, less than, equal to, or greater than 0.1 G-ohm meters, 1, 10, 100, or 1000 G-ohm meters. In various embodiments, the non-woven core layer 106 can incorporate reinforcing fibers and/or binders, as will be described later.

Another advantageous feature relates to the dielectric strength of the non-woven core layer 106, representing its ability prevent the flow of an electrical current under an applied electrical stress. Unlike many other materials found in electrical insulation applications, this layer can provide a dielectric strength of at least 0.1 kV/mm, 0.2, 0.3, 0.4, 0.5, 0.6, 0.7, 0.8, 0.9, or at least 1.0 kV/mm at ambient conditions, even after being subjected to a temperature of at least 500° C. for 5 minutes. Irrespective of thickness, the non-woven core layer 106 preferably has a breakdown voltage of at least 1 kV, 2, 3, 4, 5, 6, 7, 8, 9, or 10 kV at ambient conditions after being subjected to a temperature of at least 500° C. for 5 minutes.

The intrinsic properties of the non-woven core layer 106 enable the overall subassembly 100 in FIG. 1 to have both a high dielectric strength and thus high breakdown voltage. Further these properties provide for a high electrical resistance measured between the outward-facing and inward-facing major surfaces 102, 104 (e.g., along a direction perpendicular to the major surfaces 102, 104). Particularly useful carbonized fibers include oxidized polyacrylonitrile (OPAN) fibers. Details relating to the non-woven core layer, reinforcing fibers, and scrims are described in respective subsections below.

The adhesive layer 108 need not be particularly limited but preferably has flame-retardant properties. Suitable adhesives can include heat-activated adhesives containing polyurethanes or acrylates. In some embodiments, the adhesive is stimuli-responsive. For example, the adhesive layer 108 can be initially non-tacky, enabling it to be stored unprotected by a release liner, but become tacky upon activation by heat. Exemplary materials are described in Y. L. Dar, W. Yuan-Huffman, S. Shah, and A. Xiao, J. Adhesion Sci. Technol., 21, 1645 (2007). Adhesive compositions can also blended with flame retardant agents such as bromine, phosphate, and iodine salts. Optionally, the adhesive is a pressure-sensitive adhesive.

The plate 110 can be, in some embodiments, part of a battery assembly housing. The plate 110 is commonly made from a rigid, metallic material, such as a nickel-plated steel, stainless steel, or aluminum. The purpose of the plate 110 is to provide mechanical strength to the battery subassembly 100 and help prevent punctures or leakage in the event the battery assembly is damaged in a collision or other external factor.

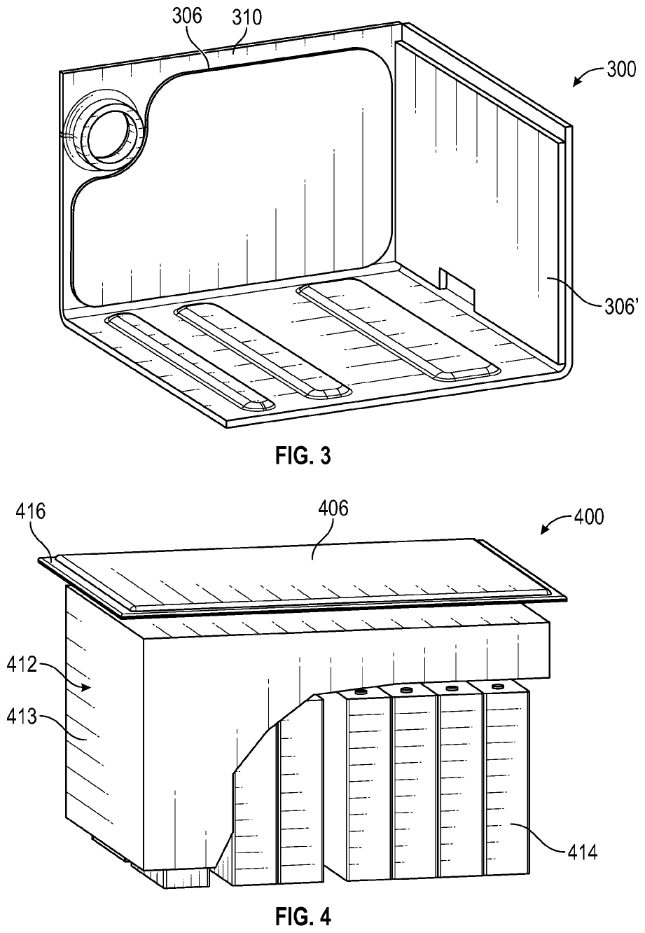

FIG. 2 shows a subassembly 200 formed into a more complex configuration. Here, the subassembly 200 includes a lid 210 having five orthogonal walls as shown that collectively define a bottom-facing cavity (not visible in FIG. 2). Assuming a shape that conforms with the cavity is a non-woven core layer 206 and two elongated strips of adhesive layer 108. The strips of adhesive layer 108 bond the non-woven core layer 206 and the lid 210 to each other.

FIG. 3 shows a subassembly 300 according to an alternative configuration, in which a plate 310 includes three orthogonal walls and two distinct non-woven core layers 306, 306′ are coupled to the walls of the plate 310. In this embodiment, the non-woven core layers 306, 306′ can be adhesively bonded to the plate 310 or attached using mechanical joint, such as using one or more clips, hooks, fasteners, or even just an interference fit provided by neighboring subassembly structures. Optionally, one or more openings could be present in the non-woven core layer 306 to accommodate a mechanical joint to be disposed on the plate 110.

FIG. 4 is a fragmentary view showing a battery subassembly 400 within a battery assembly including a battery module 412 that includes a housing 413 that at least partially encloses a plurality of individual cells 414. In some instances, the housing 413 is metallic and can be electrically-conductive. The materials used to construct the housing 413 need not be limited, and can include aluminum, steel, or a polymer composite, depending on performance and weight requirements.

Located above the battery module 412 is a non-woven core layer 406 having a sealed peripheral edge 416 and bonded to the housing 413 by an interposing adhesive layer (not visible in the figure). Advantageously, edge sealing of the peripheral edge 416 allows internal fibers within the non-woven core layer 406 to be substantially encapsulated, preventing the fibers from shedding or otherwise being dislodged during operation of the battery. Edge sealing can also help prevent or mitigate the degree of shrinkage when the non-woven core layer 406 is exposed to very high temperatures. As described in a later section, binders can be incorporated into the non-woven core layer to assist in making edge sealed configurations such as shown in FIG. 4. The depicted configuration can help reduce or eliminate current leakage from the battery module 412 during long-term use or storage.

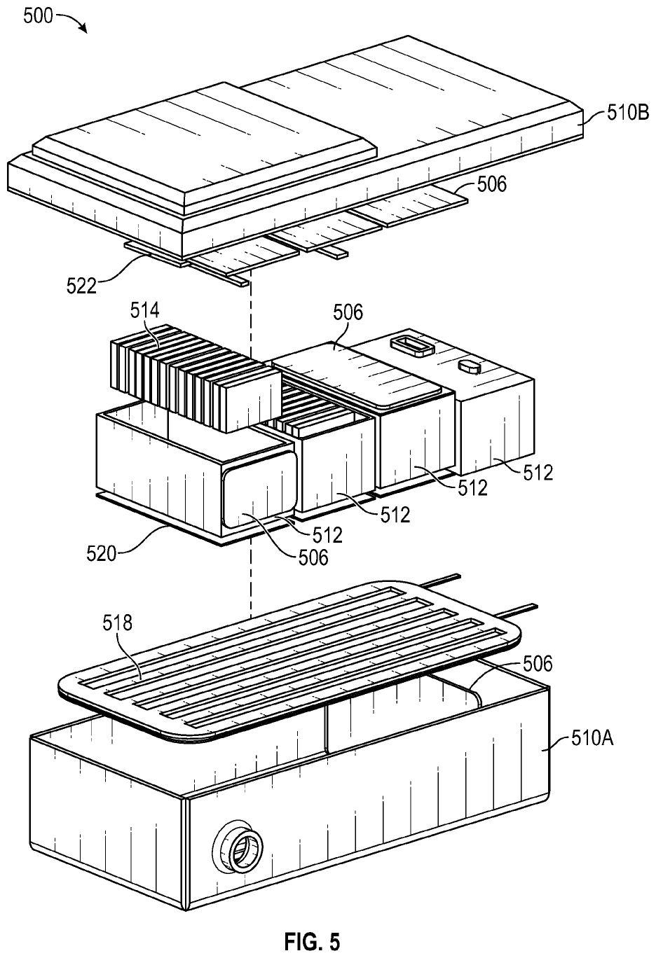

FIG. 5 shows a comprehensive battery assembly 500 in which the aforementioned electrically-insulating layered structures can be advantageously deployed. The assembly 500, shown in exploded view, incorporates components bearing many structural similarities to the battery subassemblies 100, 200, 300, 400 previously shown and described. In FIG. 5, the battery assembly 500 includes a housing collectively provided by mating components battery case 510A and battery lid 510B. Received therein are battery modules 512, each containing a plurality of individual battery cells 514 similar to those shown previously in FIG. 4. In the embodiment shown, four battery modules 512 are shown, although this number is merely exemplary.

Residing on the inner bottom surface of the case 510A beneath the battery modules 512 is a cooling plate 518, which is typically made from a highly thermally-conductive metal such as steel or aluminum, and a conformable thermal pad 520 to conduct heat from the battery modules 512 to the cooling plate 518.

Extending along the top surfaces of the battery modules 512 is a busbar 522, a strip of metal that is electrically coupled to one or more battery modules 512 within the battery assembly 500. The busbar 522 conducts an electric current and provides power distribution within the battery assembly 500. In exemplary embodiments, the busbar 522 itself is not electrically insulated. Throughout the battery assembly 500 in the space enclosed by the case 510A and lid 510B are electrically-insulating layers 506, each including at least one non-woven core layer and optionally an adhesive layer disposed thereon, as used in the subassembly 100 of FIG. 1.

Referring again to FIG. 5, the non-woven core layer is disposed between the busbar 522 and housing to electrically insulate these components from each other. Generally, electrical insulation of the busbar from housing components can be generally achieved by disposing the non-woven core layer on either the busbar or housing component and then bringing together the busbar and housing component such that the non-woven core layer is disposed between them.

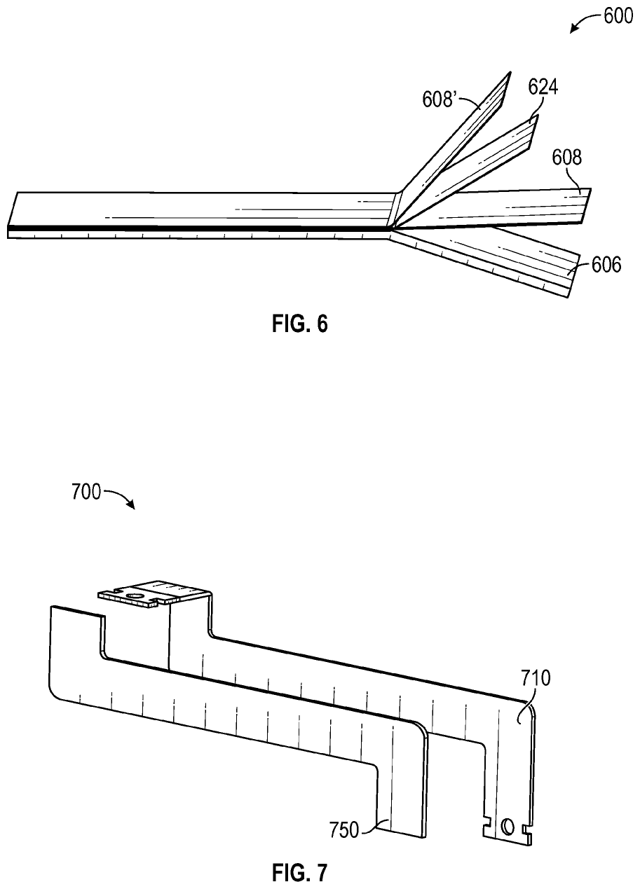

FIG. 6 shows a multi-layered electrically insulating article 650 that can be adhesively bonded to a busbar or other electrically active surface within a battery assembly. The bottom major surface of the article 650 is comprised of a non-woven core layer 606, with a first adhesive layer 608 extending across and directly contacting the non-woven core layer 606. Both are analogous to those layers of subassembly 100. A backing 624 extends across and directly contacts the first adhesive layer 608, and a second adhesive layer 608′ extends across and directly contacts the backing 624.

The backing 624 enhances the structural integrity of the article 650 and can facilitate handling by providing a non-friable layer that bonds strongly to the adhesive 608′. Advantageously, the article 650 can be transported and stored on a release liner (not shown in FIG. 6), from which it is released prior to use by gripping the backing 624 and peeling the article 650 away from the release liner. In this manner, the backing 624 can prevent delamination between the non-woven core layer 606 and the first adhesive layer 608 upon liner release that would occur if the non-woven core layer 606 and first adhesive layer 608 was directly bonded to the liner. The backing 624 can also be made from various useful electrically-insulating materials, including but not limited to, polyester, polyimide, and polyvinyl chloride.

FIG. 7 shows a busbar assembly 700 where a busbar 710 extends along three dimensions. An electrically-insulating article 750 having a shape generally matching that of the busbar 710 extends across a major surface of the busbar 710 to provide protection against shorting or current leakage along these overlapping regions. In a preferred embodiment, the electrically-insulating article 750 has a multi-layered structure such as shown in the electrically insulating article 650 of FIG. 6, and can be formed into a customized shape by a die cutting process.

Optionally, the article 750 can be ultrasonically welded to itself and/or wrapped around the busbar 710 without use of an adhesive.

### Non-Woven Core Layers

The non-woven core layer is preferably comprised of a plurality of OPAN fibers. The OPAN fibers can include, for example, those available under the trade designations PYRON (Zoltek Corporation, Bridgeton, MO) and PANOX (SGL Group, Meitingen, Germany). In a preferred embodiment, the OPAN fibers are randomly oriented within the non-woven core layer.

The OPAN fibers derive from precursor fibers containing a copolymer of acrylonitrile and one or more co-monomers. Useful co-monomers include, for example, methyl methacrylate, methyl acrylate, vinyl acetate, and vinyl chloride. The co-monomer(s) may be present in an amount of up to 15 wt %, 14 wt %, 13 wt %, 12 wt %, 11 wt %, 10 wt %, 9 wt %, or 8 wt %, relative to the overall weight of the monomer mixture prior to copolymerization.

Oxidation of the precursor fibers can be achieved by first stabilizing the precursor fibers at high temperatures to prevent melting or fusion of the fibers, carbonizing the stabilized fibers to eliminate the non-carbon elements and finally a graphitizing treatment at even higher temperatures to enhance the mechanical properties of the non-woven fibers. OPAN fibers, as referred to herein, include polyacrylonitrile fibers that are either partially or fully oxidized.

In some embodiments, the OPAN fibers are stabilized. Stabilization can be carried out by controlled heating of the precursor fiber in air or some other oxidizing atmosphere. Oxidation typically takes place at temperatures in the range of from 180° C. to 300° C., with a heating rate of from 1-2° C. per minute.

If desired, the precursor fibers can undergo further processing to reduce shrinkage. Shrinkage of the precursor fibers can be reduced by stretching the fibers along their axis during the low-temperature stabilization treatment. Such stretching can produce OPAN fibers with a high degree of preferred orientation along the fiber axis. The stabilization process produces changes in chemical structure of the acrylic precursor whereby the material becomes thermally stable to subsequent high temperature treatments. During this process, the fibers change in color to black. The black fibers are carbonized in an inert atmosphere at high temperatures, typically from 1000° C. to 1500° C., at a slow heating rate to avoid damage to the molecular order of the fiber. The fibers are given a graphitizing treatment at high temperatures for example, above 2000° C. to 3000° C. to improve the texture of the fiber and to enhance the tensile modulus of the non-woven core layer. If desired, the strength and the tensile modulus of the fibers can be further improved by stretching at elevated temperatures. With this treatment, the non-woven core layer can display a tensile strength of at least 28 kPa, as measured along any and all transverse directions.

The fibers used in the non-woven core layer can have a fiber diameter and length that enables the fibers to become entangled within the non-woven core layer. The fibers, however, are preferably not so thin that web strength is unduly compromised. The fibers can have a median fiber diameter of from 1 micrometers to 100 micrometers, from 2 micrometers to 50 micrometers, from 5 micrometers to 20 micrometers, or in some embodiments, less than, equal to, or greater than 1 micrometer, 2, 3, 5, 7, 10, 15, 20, 25, 30, 40, 50, 60, 70, 80, 90, or 100 micrometers.

Inclusion of long fibers can reduce fiber shedding and further enhance strength of the non-woven core layer along transverse directions. The fibers of the non-woven core layer can have a median fiber length of from 10 millimeters to 100 millimeters, from 15 millimeters to 100 millimeters, from 25 millimeters to 75 millimeters, or in some embodiments, less than, equal to, or greater than 10 millimeters, 12, 15, 17, 20, 25, 30, 35, 40, 45, 50, 55, 60, 65, 70, or 75 millimeters.

The OPAN fibers used to form the non-woven core layer can be prepared from bulk fibers. The bulk fibers can be placed on the inlet conveyor belt of an opening/mixing machine in which they can be teased apart and mixed by rotating combs. The fibers are then blown into web-forming equipment where they are formed into a dry-laid non-woven core layer.

As an alternative, a SPIKE air-laying forming apparatus (commercially available from FormFiber NV, Denmark) can be used to prepare nonwoven fibrous webs containing these bulk fibers. Details of the SPIKE apparatus and methods of using the SPIKE apparatus in forming air-laid webs are described in U.S. Pat. No. 7,491,354 (Andersen) and 6,808,664 (Falk et al.).

Bulk fibers can be fed into a split pre-opening and blending chamber with two rotating spike rollers with a conveyor belt. Thereafter, the bulk fibers are fed into the top of the forming chamber with a blower. The fibrous materials can be opened and fluffed in the top of the chamber and then fell through the upper rows of spikes rollers to the bottom of the forming chamber passing thereby the lower rows of spike rollers. The materials can then be pulled down on a porous endless belt/wire by a combination of gravity and vacuum applied to the forming chamber from the lower end of the porous forming belt/wire.

Alternatively, the non-woven core layer can be formed in an air-laid machine. The web-forming equipment may, for example, be a RANDO-WEBBER device commercially-available from Rando Machine Co., Macedon, NY. Alternatively, the web-forming equipment could be one that produces a dry-laid web by carding and cross-lapping, rather than by air-laying. The cross-lapping can be horizontal (for example, using a PROFILE SERIES cross-lapper commercially-available from ASSELIN-THIBEAU of Elbeuf sur Seine, 76504 France) or vertical (for example, using the STRUTO system from the University of Liberec, Czech Republic or the WAVE-MAKER system from Santex AG of Switzerland).

The OPAN fibers can be present in any amount sufficient to provide the desired electrically insulation properties, as well as flame resistance and thermal insulating properties, if also desired. The OPAN fibers can be present in an amount of from 60 wt % to 100 wt %, 70 wt % to 100 wt %, 81 wt % to 100 wt %, or in some embodiments, less than, equal to, or greater than 50 wt %, 55, 60, 65, 70, 75, 80, 85, 90, or 95 wt %, or less than or equal to 100 wt %.

In some embodiments, the non-woven core layer includes a multiplicity of fiber entanglements, where two or more discrete fibers become knotted or twisted together. The fibers within these entanglements, while not physically attached, can be so intertwined that they resist separation when pulled in opposite directions.

Entanglements can be induced by a needle tacking process or hydroentangling process. Advantageously, these processes can provide entanglements in which the fibers in the non-woven core layer are substantially entangled along directions perpendicular to the major surfaces of the non-woven core layer, thereby enhancing loft and increasing strength of the non-woven core layer along these directions.

The non-woven core layer can be entangled using a needle tacker commercially available under the trade designation DILO from Dilo of Germany, with barbed needles (commercially available, for example, from Foster Needle Company, Inc., of Manitowoc, WI) whereby the substantially entangled fibers described above are needle tacked fibers. Needle tacking, also referred to as needle punching, entangles the fibers perpendicular to the major surface of the non-woven core layer by repeatedly passing an array of barbed needles through the web and retracting them while pulling along fibers of the web.

The needle tacking process parameters, which include the type (or types) of needles used, penetration depth, and stroke speed, are not particularly restricted. Further, the optimum number of needle tacks per area of mat will vary depending on the application. Typically, the non-woven core layer is needle tacked to provide an average of at least 5 needle tacks/cm². Preferably, the mat is needle tacked to provide an average of about 5 to 60 needle tacks/cm², more preferably, an average of about 10 to about 20 needle tacks/cm².

Further options and advantages associated with needle tacking are described elsewhere, for example in U.S. Patent Publication Nos. 2006/0141918 (Rienke), 2011/0111163 (Bozouklian et al.), and International Patent Application No. PCT/CN2017/110372 (Cai et al.).

As a further option, the non-woven core layer can be hydroentangled using a conventional water entangling unit (commercially available from Honeycomb Systems Inc. of Bidderford, Me.; also see U.S. Pat. No. 4,880,168 (Randall, Jr.)). Although the preferred liquid to use with the hydroentangler is water, other suitable liquids may be used with or in place of the water.

In a water entanglement process, a pressurized liquid such as water is delivered in a curtain-like array onto a non-woven core layer, which passes beneath the liquid streams. The mat or web is supported by a wire screen, which acts as a conveyor belt. The mat feeds into the entangling unit on the wire screen conveyor beneath the jet orifices. The wire screen is selected depending upon the final desired appearance of the entangled mat. A coarse screen can produce a mat having perforations corresponding to the holes in the screen, while a very fine screen (e.g., 100 mesh) can produce a mat without the noticeable perforations.

In exemplary embodiments, the non-woven core layer has an average bulk density of from 15 kg/m³ to 300 kg/m³, 15 kg/m³ to 200 kg/m³, 15 kg/m³ to 50 kg/m³, or in some embodiments less than, equal to, or greater than 15 kg/m³, 20, 25, 30, 35, 40, 45, 50 kg/m³.

The provided non-woven core layers are capable of being both highly compressible and highly conformable. This property can confer a significant versatility in battery insulation applications, because the spacing between the metallic battery housing and busbars often follows complex, three-dimensional contours and is generally non-uniform. Since the non-woven core layer is highly flexible, it can be wrapped around curved battery modules and fit into enclosures that have varying shapes and sizes without buckling or wrinkling like film or paper insulators. The resilient nature of the core layer allows it to compressibly conform to curved surfaces along the housing and busbar components. In some cases, the non-woven core layer can expand into spaces within the battery assembly, and help restrict movement of neighboring components.

In a preferred embodiment, the non-woven core layer recovers to at least 70% of its original thickness 5 minutes after being compressed to 37% of its original thickness at ambient conditions.

### Reinforcing Fibers

In some embodiments, the non-woven core layer includes a plurality of OPAN fibers blended with a plurality of secondary fibers known as reinforcing fibers. The reinforcing fibers may include binder fibers, which have a sufficiently low melting temperature to allow subsequent melt processing of the non-woven core layer. Binder fibers are generally polymeric, and may have uniform composition or contain two or more components. In some embodiments, the binder fibers are bi-component fibers comprised of a core polymer that extends along the axis of the fibers and is surrounded by a cylindrical shell polymer. The shell polymer can have a melting temperature less than that of the core polymer.

As used herein, however, “melting” refers to a gradual transformation of the fibers or, in the case of a bi-component shell/core fiber, an outer surface of the fiber, at elevated temperatures at which the polymer (e.g., polyester) shell component becomes sufficiently soft and tacky to bond to other fibers with which it comes into contact, including OPAN fibers and other binder fibers that may have a higher or lower melting temperature as described above.

Certain thermoplastic materials such as polyester can become tacky when melted, making them suitable materials for the outer surface of a binder fiber. Useful binder fibers have outer surfaces comprised of a polymer having a melting temperature of from 100° C. to 300° C., or in some embodiments, less than, equal to, or greater than, 100° C., 105, 110, 115, 120, 125, 130, 135, 140, 145, 150, 160, 170, 180, 190, 200, 210, 220, 230, 240, 250, 260, 270, 280, 290, or 300° C.

Binder fibers increase structural integrity in the non-woven core layer by creating a three-dimensional array of nodes where constituent fibers are physically attached to each other. These nodes provide a macroscopic fiber network, which increases tear strength, tensile modulus, preserves dimensional stability of the end product, and reduces fiber shedding. Advantageously, incorporation of binder fibers can allow bulk density to be reduced while preserving structural integrity of the non-woven core layer, which in turn decreases both weight and thermal conductivity.

The reinforcing fibers can have any suitable diameter to impart sufficient loft, compressibility, and/or tear resistance to the non-woven core layer. The reinforcing fibers can have a median fiber diameter of from 10 micrometers to 1000 micrometers, 15 micrometers to 300 micrometers, 20 micrometers to 100 micrometers, or in some embodiments, less than, equal to, or greater than 10 micrometers, 15, 20, 25, 30, 35, 40, 45, 50, 60, 70, 80, 90, 100, 120, 150, 170, 200, 250, 300, 400, 500, 750, or 1000 micrometers.

The reinforcing fibers can be present in an amount of from 1 wt % to 40 wt %, 3 wt % to 30 wt %, 3 wt % to 19 wt %, or in some embodiments, equal to or greater than 0 wt %, or less than, equal to, or greater than 1 wt %, 2, 3, 4, 5, 7, 10, 15, 20, 25, 30, 35, 40, 45, or 50 wt %, relative to the overall weight of the non-woven core layer.

Preferred weight ratios of the OPAN fibers to reinforcing fibers bestow both high tensile strength to tear resistance to the non-woven core layer as well as acceptable flame retardancy—for instance, the ability to pass the UL-94V0 flame test. The weight ratio of OPAN fibers to reinforcing fibers can be at least 4:1, at least 5:1, at least 10:1, or in some embodiments, less than, equal to, or greater than 4:1, 5:1, 6:1, 7:1, 8:1, 9:1, or 10:1.

The non-woven core layers described herein can achieve surprisingly low thermal conductivity coefficients. For example, the non-woven core layer of the provided non-woven core layers can display a thermal conductivity coefficient of less than 0.035 W/K-m, less than 0.033 W/m-K, less than 0.032 W/m-K, or in some embodiments, less than, equal to, or greater than 0.031 W/m-K, 0.032, 0.033, 0.034, or 0.035 W/m-K, at ambient conditions according to ASTM D1518-85 (re-approved 2003). Thermal conductivity coefficients in these ranges can be obtained with the non-woven core layer in its relaxed configuration (i.e., uncompressed) or compressed to 20% of its original thickness based on ASTM D5736-95 (re-approved 2001).

As a further option, it is possible that the non-woven core layer includes a plurality of fibers that are neither OPAN fibers nor reinforcing fibers having an outer surface comprised of a polymer with a melting temperature of from 100° C. to 300° C. Such fibers may include, for example, polyester fibers having a melting temperature exceeding 300° C. To maximize the flame retardancy of the non-woven core layer, however, it is preferred that the OPAN fibers represent over 85 vol %, over 90 vol %, or over 95 vol % of the plurality of fibers that do not have an outer surface comprised of a polymer with a melting temperature of from 100° C. to 300° C.

Optionally, the OPAN fibers and reinforcing fibers are each crimped to provide a crimped configuration (e.g., a zigzag, sinusoidal, or helical shape). Alternatively, some or all of the OPAN fibers and reinforcing fibers have a linear configuration. The fraction of OPAN fibers and/or reinforcing fibers that are crimped can be less than, equal to, or greater than 5%, 10, 15, 20, 25, 30, 40, 50, 60, 70, 80, 90, or 100%. Crimping, which is described in more detail in European Patent No. 0 714 248, can significantly increase the bulk, or volume per unit weight, of the non-woven core layer.

### Binders

The non-woven core layer optionally includes a binder to enable edge sealing of the electrical insulator. The binder can be disposed on the optional scrims and/or the non-woven core layer. The presence of the binder allows the peripheral edge of the optional scrim(s) to be edge sealed by melting at least part of the binder.

The binder can take many forms. In some embodiments, the binder is provided through inclusion of binder fibers as described above. Useful binder fibers can include bicomponent fibers, including melty fibers, or monocomponent fibers. As an example, a suitable bicomponent fiber could include a polyester or nylon core with a low melting polyolefin sheath. As a further example, the bicomponent fiber could have a polyester core with a polyester-polyolefin copolymer sheath such as Type 254 CELBOND fiber provided by KoSa, Houston, TX. This fiber has a sheath component with a melting temperature of approximately 230° F. (110° C.). The binder fibers can also be a polyester homopolymer or copolymer rather than a bi-component fiber.

Suitable monocomponent fibers include thermoplastic fibers with softening temperature less than 150° C. (such as polyolefin or nylon). Other suitable monocomponent fibers include thermoplastic fibers with softening temperature less than 260° C. (such as certain polyester fibers). For enhanced loft, it is beneficial for these binder fibers to be crimped, as mentioned above with respect to the reinforcing fibers.

Optionally, these binder fibers can also function as reinforcing fibers for the non-woven core layer. Alternatively, the binder fibers may be blended into the non-woven core layer as a separate component from the reinforcing fibers described in the previous section.

In other embodiments, the binder is provided by a coating. The coating can be disposed on the optional scrims, the non-woven core layer, or both. The coating can be applied using any known method, such as solution casting or hot melt coating. Useful solution casting methods including brush, bar, roll, wiping, curtain, rotogravure, spray, or dip coating techniques.

Coatings effective in edge sealing the non-woven core layer include those made from an acrylic polymer latex or polyurethane based latex. Exemplary polymeric binders include Dow POLYCO 3103 (acrylic/vinyl acetate copolymer), Dow RHOPLEX HA-8, and DSM NEWREZ R-966 (polyurethane based latex). Other useful binder materials include fluorinated thermoplastics, optionally in the form of an aqueous emulsion, such as those provided under the trade designation THV and provided by 3M Company, St. Paul, MN.

The latex can be cast onto the optional scrims and/or the non-woven core layer from an aqueous solution. The latex binder can be present in any suitable amount relative to the solids content of the aqueous solution. The latex binder can be present in an amount of from 1 wt % to 70 wt %, 3 wt % to 50 wt %, 5 wt % to 20 wt %, or in some embodiments, less than, equal to, or greater than 1 wt %, 2, 3, 4, 5, 7, 10, 12, 15, 17, 20, 25, 30, 35, 40, 45, 50, 55, 60, 65 or 70 wt % based on the overall solids weight of the coating.

The binder can also provide adhesion between the optional scrims and the non-woven core layer. This can be achieved by coating the binder onto inner surfaces of the optional scrim(s) before placing the scrims in contact with the non-woven core layer. Optionally, the binder can be spray coated onto these inner surfaces from solution.

The coating should be sufficiently thick to form an edge seal that is generally uniform and void-free when the optional scrims, and the non-woven core layer, are subjected to heat and/or pressure. The minimum coating weight for a given application would depend on the porosity and thickness of the scrims and non-woven core layer, among other factors. In exemplary embodiments, the coating has a basis weight (in grams per square meter, or “gsm”) of from 2 gsm to 100 gsm, from 5 gsm to 50 gsm, from 10 gsm to 20 gsm, or in some embodiments, less than, equal to, or greater than 2 gsm, 3, 4, 5, 7, 10, 12, 15, 17, 20, 25, 30, 35, 40, 45, 50, 55, 60, 65, 70, 75, 80, 85, 90, 95, or 100 gsm.

It can be advantageous for the coating to contain other components in addition to the binder. For example, where the binder is not flame-resistant, the coating can further include a flame retardant additive.

Flame tests conducted on these articles used to measure compliance with the UL94-V0 flammability standard revealed that thin sections in the non-woven core layer are most vulnerable to burning. Further, edge sealing of the non-woven core layer results in areas of reduced thickness and was also discovered to reduce the degree of expansion when subjected to very high temperatures (e.g., exceeding 500° C.). As a result, the addition of a flame retardant into the coating applied to edge sealed areas was found to have an especially significant effect in enhancing overall fire resistance. In certain embodiments, this modification enables the non-woven core layer to pass the UL94-V0 flammability standard. Surprisingly, it was discovered that, in some embodiments, the multilayer non-woven core layer as a whole can pass the UL94-V0 flammability standard, even when the non-woven core layer and the scrims individually cannot.

Useful flame retardant additives include phosphate-based additives, such as ammonium polyphosphate. Ammonium polyphosphate is an inorganic salt of polyphosphoric acid and ammonia, and may be either a linear or branched polymer. Its chemical formula is [NH₄PO₃]ₙ(OH)₂, where each monomer consists of an orthophosphate radical of a phosphorus atom with three oxygens and one negative charge neutralized by an ammonium cation leaving two bonds free to polymerize. In the branched cases some monomers are missing the ammonium anion and instead link to other monomers. Organophosphates other than ammonium polyphosphate can also be used.

Other additives that can enhance fire resistance of the coating include intumescents, or substances that swell as a result of heat exposure. In the provided non-woven core layers, an intumescent additive can include one or more of: (1) a phosphorus-containing part, provided for example by ammonium polyphosphate, (2) a hydroxyl-containing part that increases char in the event of a fire, such as sucrose, catechol, pentaerythritol (“PER”), and gallic acid, and (3) a nitrogen-containing part that can act as blowing agent, such as melamine or ammonium. In a preferred embodiment, components (1)-(3) are all used in combination. Intumescents can also include graphite filler, such as expandable graphite. Expandable graphite is a synthesized intercalation compound of graphite that expands when heated.

The flame retardant additive can be dissolved or dispersed with the binder in a common solvent and both components solution cast onto the scrims and/or the non-woven core layer. Conveniently, ammonium polyphosphate can be cast from an aqueous solution that also contains a polymer latex.

The flame retardant additive can be present in an amount of from 5 wt % to 95 wt %, from 10 wt % to 90 wt %, from 20 wt % to 60 wt %, or in some embodiments, less than, equal to, or greater than 5 wt % 10, 15, 20, 25, 30, 35, 40, 45, 50, 55, 60, 65, 70, 75, 80, 85, 90, or 95 wt % based on the overall solids weight of the coating.

The aqueous solution itself can have any suitable concentration to provide an appropriate viscosity for the selected coating method, and provide for a uniform coating on the fibers of the scrims and/or the non-woven core layer. For spray coating, it is typical to use a solids content of from 1 wt % to 50 wt %, from 2.5 wt % to 25 wt %, from 5 wt % to 15 wt %, or in some embodiments, less than, equal to, or greater than 1 wt %, 1.5, 2, 2.5, 3, 3.5, 4, 4.5, 5, 6, 7, 8, 9, 10, 12, 15, 17, 20, 25, 30, 35, 40, 45, or 50 wt %.

### Scrims

While not required, one or more scrims can be disposed on the non-woven core layer. The scrims need not be particularly restricted, and can include any type of open mesh structure that is either woven or non-woven. Scrims can provide the non-woven core layer with additional strength and stiffness, if desired.

Woven scrims may have any type of weave, and non-woven scrims are produced using any well-known technique, including melt blowing, spun lace and spun bond techniques.

Non-woven scrims include those made from any of a broad variety of fibers including polyethylene fibers, polypropylene fibers, mixtures of polyethylene and polypropylene fibers, nylon fibers (such as the nylons described above), polyester fibers (such as the polyesters described above), acrylic and modacrylic fibers such as polyacrylonitrile fibers and acrylonitrile and vinylchloride copolymer fibers, polystyrene fibers, polyvinylacetate fibers, polyvinylchloride fibers, cellulose acetate fibers, glass fibers and viscose fibers. In addition to the above synthetic fibers there may also be used the natural fibers such as cotton or wool.

In the provided non-woven core layers, suitable polymeric fibers used to produce the scrim include polyamides, polyesters and polyolefins, particularly polyethylene and polypropylene, or a combination thereof. The scrim may also contain fiberglass. In some embodiments, the open mesh fabric comprises at least one nylon, a high-density polyethylene or a combination thereof.

In various embodiments, each of the scrims is composed of flame-resistant fibers. While fiberglass fibers have better intrinsic fire resistance than the aforementioned polymers, even combustible polymers can be provided with significant fire resistance by blending with sufficient amounts of a flame retardant additive. For example, these scrims can be made from polyester fibers that display some degree of flame-resistance.

The flame retardant additive can be either miscible or immiscible with the host polymer. Miscible additives include polymer melt additives such as phosphorus-based flame retardants that contain phenolic end groups. Polyphosphonates, including polyphosphonate homopolymers and copolymers, can also be miscibly blended with polyesters to form flame-resistant fibers. Useful additives are commercially available under the trade designation NOFIA from FRX Polymers, Inc., Chelmsford, MA. Generally, miscible additives are preferred in making scrims with fine fiber diameters. If fiber diameters are larger than 10 micrometers, then inclusion of certain immiscible salts could also be used to enhance fire resistance.

Flame-resistant fibers can be, in some embodiments, capable of passing the UL94-V0 flammability standard when formed into a non-woven web made from 100% of such fibers, and having a base weight of less than 250 gsm and web thickness of less than 6 millimeters.

Suitable scrims need not be fibrous. Scrims can, for example, include continuous films that are perforated to form a mesh-like structure. Useful scrims can be made from a perforated film, such as described in U.S. Pat. No. 6,617,002 (Wood), 6,977,109 (Wood), and 7,731,878 (Wood).

The scrims are generally much thinner than the non-woven core layer. To minimize the weight of the non-woven core layer, the scrims can be made only as thick as necessary to serve the purpose of encapsulating loose fibers in the non-woven core layer while satisfying any technical requirements for strength and toughness. In a preferred embodiment, one or both scrims have a basis weight of from 10 gsm to 100 gsm, from 20 gsm to 80 gsm, from 30 gsm to 70 gsm, or in some embodiments, less than, equal to, or greater than 10 gsm, 12, 15, 17, 20, 25, 30, 35, 40, 45, 50, 55, 60, 65, 70, 75, 80, 85, 90, 95, or 100 gsm.

Further variants are possible. For example, the fibers in the non-woven core layer and/or scrim can be coated with other compositions that are not binders. The coating on the fibers can be selected from, for example, silicones, acrylates, and fluoropolymers whereby the non-woven core layer has an emissivity of less than 0.5. Here, “emissivity” is defined as the ratio of the energy radiated from a material's surface to that radiated from a blackbody (a perfect emitter) at the same temperature and wavelength and under the same viewing conditions. Reducing emissivity helps lower the extent to which a material loses heat from thermal radiation.

Coating the constituent fibers of the non-woven core layer can impart significant functional and/or aesthetic benefits. For example, coating the fibers has the effect of reinforcing the fibers, thus increasing the overall strength of the web. Certain coating materials, such as fluoropolymers and silicones, may enhance resistance to staining or fouling because of airborne substances becoming adhered to fiber surfaces. In some applications it can be desirable to sheath the fibers in an opaque coating, can also be used to change the color of the non-woven core layer, which would be generally be black or grey for OPAN fibers or other carbonized fibers.

The non-woven core layers can have any suitable thickness based on the space allocated for a given application. The non-woven core layers can have a thickness of from 1 millimeter to 50 millimeters, from 2 millimeters to 25 millimeters, from 3 millimeters to 20 millimeters, or in some embodiments, less than, equal to, or greater than 1 millimeter, 2, 3, 4, 5, 6, 7, 8, 9, 10, 12, 15, 17, 20, 22, 25, 27, 30, 35, 40, 45, or 50 millimeters.

The provided non-woven core layers can be made in a variety of ways, including batch methods and continuous methods.

In an exemplary manufacturing process, bulk fibers of the non-woven core layer, such as OPAN fibers, are initially fed into a carding process. These fibers can be blended with optional reinforcing fibers and/or binder fibers, such as a high temperature polyester fiber. In an exemplary process, OPAN fibers are blended with a high temperature polyethylene terephthalate staple fiber and carded to form a non-woven core layer having a thickness of about 8 mm.

The top and bottom major surfaces of the web are then spray coated with a binder solution. Dispersed in the solution is a polymeric binder and optionally a soluble flame retardant additive to improve the fire resistance of the coating. Based on environmental, health, and safety factors, it can be advantageous to use an aqueous binder solution, and avoid the need for volatile organic solvents. In alternative embodiments, the spray coating is applied only to the top or only to the bottom major surface of the web.

The spray coating step can result in the binder solution penetrating deeply into the non-woven core layer, depending on the spraying technique, size of the spray droplets and thickness of the layer. In some embodiments, the depth of penetration is 100%, or greater than, equal to, or less than 95%, 90, 85, 80, 75, 70, 65, 60, 55, or 50%, relative to the thickness of the non-woven core layer.

Edge sealing can be achieved using any number of useful methods. One method involves direct application of heat and pressure simultaneously by placing the open-edged non-woven core layer in contact with a tool having one or more heated surfaces. In some embodiments, the surfaces are metal tool surfaces.

Instead of using a heated tool, it is possible to heat one or both major surfaces of the open-edged non-woven core layer immediately prior to pressing it between unheated tool surfaces to edge seal the non-woven core layer. Heat can be imparted by heated air (e.g., by convective heating) or by exposure to light (e.g., radiative heating). In some embodiments, the scrim surfaces are joined together using ultrasonic welding. Advantageously, heat or ultrasonic welding can be performed along a narrow linear section of the non-woven core layer to facilitate its bending along a corresponding bent section of the underlying busbar or housing component. Ultrasonic welding can also be used to bond the non-woven core layer to plastic or composite battery components, or to facilitate wrapping of the non-woven core layer around a busbar or other electrically-conductive battery component.

After edge sealing, it is generally desirable for the sealed non-woven core layer to be cleanly removable from the tool surfaces. Clean removal can be facilitated by judicious selection of the binder. To avoid sticking issues, it is preferred that the softening temperature (e.g., T g) of the binder is well below the softening point of the scrim. If the scrim is made from a semi-crystalline polymer such as a polyester, this softening temperature can correspond to its melting temperature. Using an edge seal temperature well below the melting temperature of the scrim also helps avoid inducement of brittleness in the scrim that can result from melting and re-crystallization in the fiber polymer.

Further options and advantages associated with edge sealing these layered constructions can be found in PCT Patent Publication No. WO 2020/019114 (Wu, et al.).

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

TABLE 1
Materials

| Designation | Description | Source |
|---|---|---|
| 467MP | 200MP acrylic adhesive transfer tape | 3M Company, |
| | available under the designation | St. Paul, |
| | Adhesive Transfer Tape 467MP | MN. United |
| | | States |
| 7956MP | Polyester film carrier with acrylic | 3M Company |
| | adhesive on each side available under | |
| | the designation Membrane Switch | |
| | Spacer 7956MP | |
| 7957MP | Polyester film carrier with acrylic | 3M Company |
| | adhesive on each side available under | |
| | the designation Membrane Switch | |
| | Spacer 7957MP | |
| 7959MP | Polyester film carrier with acrylic | 3M Company |
| | adhesive on each side available under | |
| | the designation Membrane Switch | |
| | Spacer 7959MP | |
| 7961MP | Polyester film carrier with acrylic | 3M Company |
| | adhesive on each side available under | |
| | the designation Membrane Switch | |
| | Spacer 7961MP | |
| 93010LSE | High strength double coated acrylic | 3M Company |
| | tape available under the designation | |
| | High Strength Double Coated Tape | |
| | 93010LE | |
| BC765 | A flame retardant polyethylene | Precision Fabrics |
| | terephthalate and rayon scrim | Group, Inc., |
| | material, 70 gsm, available under the | Greensboro, NC. |
| | designation “Nexus BC765” | |
| F9469PC | Transparent double sided 100MP | 3M Company |
| | acrylic adhesive transfer tape available | |
| | under the trade designation “VHB | |
| | Adhesive Transfer Tape F9469C” | |
| GPT-020 | Double sided adhesive tape with | 3M Company |
| | polyester carrier available under the | |
| | designation GPT-020F | |
| HT363 | High temperature aluminum foil/ | 3M Company |
| | glass cloth tape available under the | |
| | designation 363. | |
| OPAN | Oxidized polyacrylonitrile staple | ZOLTEK |
| | fibers, 1.7 dTex available under the | Corporation |
| | trade designation “OX” | (wholly owned |
| | | subsidiary of |
| | | Toray Group), |
| | | Bridgeton, MO. |
| | | United States |
| T270 | A flame retardant polyethylene | Trevira GmbH, |
| | terephthalate staple fiber, 6.5 dTex, | Hattersheim, |
| | available under the trade designation | Germany. |
| | “TREVIRA 270” | |

### Test Methods

### Thickness Measurement:

The method of ASTM D5736-95 was followed, according to test method for thickness of high loft nonwoven fabrics. The plate pressure was calibrated at 0.002 psi (13.790 Pascal).

### Breakdown Voltage Test:

The methods of IEC 60243-1 were followed. 11 cm×11 cm samples were manually applied to 15 cm×20 cm aluminum sheets. Samples were either tested alone or bonded to the aluminum sheets with adhesive using a two-kilogram pressure roller. The samples were subjected to 1000 volts at ambient temperature and then exposed to 500° C. in a THERMOLYNE 1200C muffle furnace (obtained from Thermo Fisher Scientific of Waltham, MA. United States) for five minutes. The samples were cooled to ambient conditions, and the breakdown voltage for each (in kV) was measured and recorded. Three samples were tested, and an average value was recorded.

### Hot-Side/Cold-Side Test

In an MTS Insight 5 kN tensile test machine (obtained from MTS Insight of Eden Prairie, MN, United States), a bottom platen was heated to 500° C., and a 11 cm×11 cm sample attached to either an eCoated 15 cm×20 cm steel or ceramic sheet was placed on top of it. The upper platen, with a thermocouple embedded, was lowered such that the distance (i.e., gap) between the two platens was held at a constant or set distance (e.g., 1.0 mm, 3.0 mm, and 6.0 mm). The temperature increase at the cold-side was recorded with respect to time (continuously) until it reached 600 seconds (10 minutes).

### Water/Moisture Absorption Test:

The methods of ISO 62 plastic water absorption were followed. Water absorption was measured at specific temperature and relative humidity conditions for predetermined durations of time (e.g., 23° C. at 38%, 50%, and 95% RH for 24 hours).

Nonwoven webs used in the following examples were produced by processes and techniques described in the commonly owned PCT Patent Publication No. WO 2015/080913 (Zillig et al.) unless otherwise stated.

### Example 1 (EX1)

An 80 wt. % OPAN and 20 wt. % T270 blended web was produced. The web was folded upon itself (changing basis weight to 150 gsm) and was then conveyed by a DILO Needle Loom, Model DI-Loom OD-1 6 having a needle board array of 23 rows of 75 needles/row where the rows are slightly offset to randomize the pattern. The needles were Foster 20 3-22-1.5B needles. The array was roughly 17.8 cm (7 inches) deep in the machine direction and nominally 61 cm (24 inches) wide with needle spacings of roughly 7.6 mm (0.30 inches). The needle board was operated at 91 strokes/minute to entangle and compact the web to a roughly 5.1-mm (0.20 inch) thickness. The basis weight of the blended web was 150 gsm ±10%. The blended web was then heated in the oven at 249° C. (480° F.) enhancing entanglement and strength. BC765 scrims were placed on the top and bottom of the blended web. The basis weight of the blended web with two scrims was 290 gsm ±10%. Samples underwent Dielectric strength, Hot-Side/Cold-Side and Water/Moisture Absorption Testing. Results are represented in Tables 2, 3, 4, and 5.

TABLE 2
Breakdown Voltage Test Results

| Exposed to 500° C. | No | Yes | No | No |
|---|---|---|---|---|
| Temperature (° C.) | 23 | 23 | 50 | 38 |
| Humidity (%) | 50 | 50 | 0 | 95 |
| Duration (hours) | 24 | 24 | 24 | 24 |
| Breakdown voltage (kV) | 5.75 | 2.5 | 7.35 | 2.7 |

TABLE 3
Hot-Side/Cold-Side Test Results (eCoated Steel Sheet)

| | Temperature (° C.) | | |
|---|---|---|---|
| Time (seconds) | 1 mm Gap | 3 mm Gap | 6 mm Gap |
| 0 | 25.2 | 23.1 | 22.5 |
| 60 | 42.5 | 27.2 | 24.4 |
| 120 | 61.8 | 34.7 | 28.6 |
| 180 | 78.6 | 42.9 | 33.6 |
| 240 | 93.9 | 51.0 | 38.6 |
| 300 | 107.0 | 58.6 | 43.8 |
| 360 | 118.4 | 65.6 | 48.8 |
| 420 | 128.2 | 72.0 | 53.6 |
| 480 | 136.5 | 77.7 | 57.9 |
| 540 | 143.6 | 82.9 | 61.7 |
| 600 | 149.8 | 87.4 | 65.3 |

TABLE 4
Hot-Side/Cold-Side Test Results (Ceramic Sheet)

| | Temperature (° C.) | | |
|---|---|---|---|
| Time (seconds) | 1 mm Gap | 3 mm Gap | 6 mm Gap |
| 0 | 29.3 | 26.5 | 27.2 |
| 60 | 137.4 | 84.5 | 61.6 |
| 120 | 209.9 | 126.9 | 86.8 |
| 180 | 257.1 | 158.1 | 106.4 |
| 240 | 285.7 | 182.0 | 122.9 |
| 300 | 306.0 | 201.1 | 136.6 |
| 360 | 319.4 | 216.4 | 147.8 |
| 420 | 328.5 | 229.3 | 157.6 |
| 480 | 335.4 | 240.0 | 166.3 |
| 540 | 341.0 | 248.9 | 173.7 |
| 600 | 345.5 | 256.5 | 180.4 |

TABLE 5
Water/Moisture Absorption Test Results

| | | | | |
|---|---|---|---|---|
| Temperature (° C.) | 50 | 23 | 38 | 38 |
| Relative Humidity (%) | 0 | 50 | 95 | 95 |
| Duration (hours) | 96 | 24 | 24 | 168 |
| Weight Increase (%) | 0.0 | 3.0 | 19.0 | 19.0 |

### Example 2 (EX2)

Blended webs were produced as described in Example 1 and the edges of the samples were ultrasonically sealed. A layer of 93010LSE was manually applied to a top surface of the blended web. Samples were further secured by using a two-kilogram pressure roller and then bonded to a 2-millimeter thick aluminum sheet. Samples underwent Breakdown Voltage Testing and the results are represented in Table 6.

### Example 3 (EX3)

Blended webs were produced as described in Example 1 and the edges of the samples were ultrasonically sealed. A layer of GPT-020F was manually applied to a top surface of the blended web. Samples were further secured by using a two-kilogram pressure roller and then bonded to a 2-millimeter thick aluminum sheet. Samples underwent Breakdown Voltage Testing and the results are represented in Table 6.

### Example 4 (EX4)

Blended webs were produced as described in Example 1 and the edges of the samples were ultrasonically sealed. A layer of 467MP was manually applied to a top surface of the blended web. A 100 micrometer PET film (obtained from 3M Company) was placed manually on top of the 467MP. Another 467MP layer was then manually applied to the top of the PET film. Samples were further secured by using a two-kilogram pressure roller and then bonded to a 2-millimeter thick aluminum sheet. Samples underwent Breakdown Voltage Testing and the results are represented in Table 6.

TABLE 6
Breakdown Voltage Test Results

| Example | EX2 | | EX3 | | EX4 | |
|---|---|---|---|---|---|---|
| After 500° C. | No | Yes | No | Yes | No | Yes |
| Temperature (° C.) | 23 | 23 | 23 | 23 | 23 | 23 |
| Humidity (%) | 50 | 50 | 50 | 50 | 50 | 50 |
| Breakdown voltage (kV) | 8.8 | 1.9 | 12.2 | 1.3 | 12.2 | 2.3 |

### Examples 5-8 (EX5-EX8)

Blended webs were produced as described in Example 1 and the edges of the samples were ultrasonically sealed. A layer of either 7956MP (EX5), 7957MP (EX6), 7959MP (EX7), or 7961MP (EX8) was manually applied to a top surface of the blended web. Samples were further secured by using a two-kilogram pressure roller and then bonded to a 2-millimeter thick aluminum sheet. Samples underwent Breakdown Voltage Testing and the results are represented in Table 7.

TABLE 7
Breakdown Voltage Test Results

| Example | EX5 | | EX6 | | EX7 | | EX8 | |
|---|---|---|---|---|---|---|---|---|
| Exposed to | No | Yes | No | Yes | No | Yes | No | Yes |
| 500° C. | | | | | | | | |
| Temperature | 23 | 23 | 23 | 23 | 23 | 23 | 23 | 23 |
| (° C.) | | | | | | | | |
| Humidity (%) | 50 | 50 | 50 | 50 | 50 | 50 | 50 | 50 |
| Breakdown | 11.8 | 1.1 | 15.2 | 1.7 | 21.7 | 2.0 | 22.0 | 2.3 |
| voltage (kV) | | | | | | | | |

### Example 9 (EX9)

Blended webs were produced as described in Example 1 and the edges of the samples were ultrasonically sealed. A layer of 7961MP was manually applied to a top surface of the blended web. Samples were further secured by using a two-kilogram pressure roller and then bonded to a 2-millimeter thick aluminum sheet. On the other side of the sample, a layer of HT363 was applied. Samples underwent Breakdown Voltage Testing and the results are represented in Table 8.

### Example 10 (EX10)

Blended webs were produced as described in Example 1 and the edges of the samples were ultrasonically sealed. A layer of 93010LSE was manually applied to a top surface of the blended web. Samples were further secured by using a two-kilogram pressure roller and then bonded to a 2-millimeter thick aluminum sheet. On the other side of the sample, a layer of HT363 was applied. Samples underwent Breakdown Voltage Testing and the results are represented in Table 8.

TABLE 8
Breakdown Voltage Test Results

| | | |
|---|---|---|
| Example | EX9 | EX10 |

| | | | | |
|---|---|---|---|---|
| Exposed to 500° C. | No | Yes | No | Yes |
| Temperature (° C.) | 23 | 23 | 23 | 23 |
| Humidity (%) | 50 | 50 | 50 | 50 |
| Breakdown voltage (kV) | N/A | 3.1 | N/A | 3.1 |

### Example 11 (EX10)

Blended webs were produced as described in Example 1 and the edges of the samples were ultrasonically sealed. A layer of 93010LSE was manually applied to a top surface of the blended web. An 11 cm×11 cm sample was further secured by using a two-kilogram pressure roller and then bonded to a 2-millimeter thick 15 cm×20 cm eCoated steel sheet obtained from DEFTA Group of Madrid, Spain. The sample was exposed to hot air emitted by a GHG 650LCE hot air gun (obtained from Bosch of Gerlingen, Germany) at 10 cm from the gun nozzle at maximum power (2300 Watts) and temperature (650° C.). Temperature (in ° C.) was measured and recorded with several K thermocouples placed: 1) on the surface of the sample, 2) between the sample and the eCoated steel sheet, and 3) on the other side of the eCoated steel sheet. Results of the testing are represented in Table 9.

TABLE 9
Hot Air Gun Test Results

| | Thermocouple Location (temperatures in ° C.) | | |
|---|---|---|---|
| Time (s) | 1 | 2 | 3 |
| 0 | 503.0 | 164.0 | 131.0 |
| 30 | 505.8 | 169.7 | 141.9 |
| 60 | 502.9 | 175.5 | 146.3 |
| 90 | 506.6 | 180.6 | 151.0 |
| 120 | 504.4 | 183.9 | 157.5 |
| 150 | 510.2 | 186.4 | 155.5 |
| 180 | 508.4 | 180.1 | 157.4 |
| 210 | 510.1 | 190.0 | 158.8 |
| 240 | 506.8 | 191.1 | 159.2 |
| 270 | 513.6 | 192.0 | 160.1 |
| 300 | 507.5 | 192.7 | 160.7 |
| 330 | 512.6 | 193.0 | 161.0 |
| 360 | 511.0 | 193.2 | 160.7 |
| 390 | 512.1 | 193.5 | 161.2 |
| 420 | 509.8 | 193.3 | 161.2 |
| 450 | 514.0 | 193.5 | 161.0 |
| 480 | 508.8 | 193.6 | 161.0 |
| 510 | 509.1 | 193.4 | 160.8 |
| 540 | 511.5 | 193.6 | 160.7 |
| 570 | 512.6 | 193.3 | 160.7 |
| 600 | 510.8 | 193.3 | 160.5 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A battery assembly comprising:
an electrically-conductive housing;
one or more battery modules electrically coupled to a busbar, the one or more battery modules and busbar being received in the housing; and
a non-woven core layer disposed between the busbar and electrically-conductive housing,
wherein the non-woven core layer comprises a plurality of fibers, the plurality of fibers comprising 60-100 wt % of oxidized polyacrylonitrile fibers.

2. The battery assembly of claim 1, wherein the non-woven core layer exhibits a breakdown voltage of at least 0.9 kV at ambient conditions after exposure to 500° C. for 5 minutes.

3. The battery assembly of claim 1, wherein one major surface of the non-woven core layer, at a thickness of 6 millimeters, can be heated to 500° C. for 5 minutes while maintaining a temperature at or below 300° C. on an opposing major surface of the non-woven core layer for the 5 minutes.

4. The battery assembly of claim 1, wherein the non-woven core layer compressibly conforms to a curved surface along either the busbar or electrically-conductive housing.

5. The battery assembly of claim 1, wherein the plurality of fibers are substantially entangled along directions perpendicular to a major surface of the non-woven core layer.

6. The battery assembly of claim 1, wherein the non-woven core layer contains 3-30 wt % of reinforcing fibers having an outer surface comprised of a polymer with a melting temperature of from 100° C. to 300° C.

7. The battery assembly of claim 1, wherein the oxidized polyacrylonitrile fibers represent over 85 vol % of the plurality of fibers that are not reinforcing fibers.

8. The battery assembly of claim 1, wherein the plurality of fibers comprise needle tacked fibers.

9. The battery assembly of claim 1, wherein the oxidized polyacrylonitrile fibers have a median fiber diameter of from 1 micrometers to 100 micrometers.

10. The battery assembly of claim 9, wherein the oxidized polyacrylonitrile fibers have a median fiber diameter of from 5 micrometers to 20 micrometers and a median fiber length of from 25 millimeters to 75 millimeters.

11. The battery assembly of claim 1, wherein the non-woven core layer recovers to at least 70% of its original thickness 5 minutes after being compressed to 37% of its original thickness at ambient conditions.

12. The battery assembly of claim 1, wherein the plurality of fibers are randomly oriented.

13. The battery assembly of claim 1, wherein the non-woven core layer has a tensile strength of more than 28 kPa along any transverse direction.

14. The battery assembly of claim 1, wherein the non-woven core layer passes the UL-94V0 flame test.

15. The battery assembly of claim 1, further comprising one or more scrims disposed on opposing major surfaces of the non-woven core layer, wherein a peripheral edge of the one or more scrims is edge sealed to substantially encapsulate the non-woven core layer within the one or more scrims.

16. The battery assembly of claim 15, wherein each scrim comprises flame-resistant polyester fibers.

17. The battery assembly of claim 1, wherein at least some portion of the non-woven core layer is ultrasonically welded to facilitate bending of the non-woven core layer along a bent section of the busbar or electrically-conductive housing.

18. A method of electrically insulating a battery housing from a busbar within a battery assembly, the method comprising:
disposing a non-woven core layer on either the busbar or at least a portion of the battery housing; and
bringing together the battery housing and the busbar whereby the non-woven core layer is disposed therebetween,
wherein the non-woven core layer comprises a plurality of fibers, the plurality of fibers comprising 60-100 wt % of oxidized polyacrylonitrile fibers.

19. The method of claim 18, wherein the non-woven core layer exhibits a breakdown voltage of at least 0.9 kV at ambient conditions after exposure to 500° C. for 5 minutes.

20. The method of claim 18, wherein the non-woven core layer is adhesively bonded to either the battery housing or busbar.
